(19) United States
(12) Patent Application Publication
(10) Pub. No.: US 2026/0077535 A1
(43) Pub. Date: Mar. 19, 2026

(54) METHOD OF MACHINING PARALLEL GROOVES IN THE UNDERSIDE OF A FLOOR PANEL

(71) Applicant: "BARLINEK" SPÓLKA AKCYJNA, Kielce (PL)

(72) Inventor: Marek KONSTANCZAK, Barlinek (PL)

(21) Appl. No.: 19/110,896

(22) PCT Filed: Mar. 5, 2024
(86) PCT No.: PCT/IB2024/052116

§ 371 Date: Mar. 12, 2025

(30) Foreign Application Priority Data
May 11, 2023 (PL) PL444857

(51) Int. Cl. B27M 3/04; B27F 1/04

(52) U.S. Cl. CPC B27M 3/04; B27F 1/04

(57) ABSTRACT

According to the method, a floor panel (2) is inserted between a lamellar retaining transport assembly (7) and a lamellar pressing transport assembly (8, 9); the floor panel (2) clamped between the moved lamellar retaining transport assembly (7) and the lamellar pressing transport assembly (8, 9) is subjected to a feed motion through linear movement; a cutting head (10, 11) is put into a rotary motion around axes of rotation (X1, X2) and parallel grooves (17, 21, 22) are machined in the underside (12) of the floor panel (2), using the feed motion imparted to it by the lamellar retaining transport assembly (7) and the lamellar pressing transport assembly (8, 9). The machining of the parallel grooves (17, 21, 22) in the underside (12) of the floor panel (2) is performed with the cutting head (10, 11) comprising a set of axially separated profile disc cutters having stepwise-changing diameters, the machining of the parallel grooves (17, 21, 22) being performed when the axis of rotation (X1, X2) of the spindle (23, 24) of the cutting head (10, 11) is inclined at an angle (+α, −α) relative to the plane of the underside (12) of the machined floor panel (2).

The subject of the invention is a method of machining parallel grooves in the underside of a floor panel. The invention is applicable to the production of floor panels of various materials, in particular wood, wood-based materials, mineral-synthetic or synthetic materials. Creating grooves in the underside of the floor panel allows ventilation of the underfloor space and is a prerequisite for a healthy microclimate in living areas, ensuring the safety of users of flats, in which the panels have been used as flooring.

### BACKGROUND ART

Floor panels known from the Polish patent PL191233B1 are provided with at least one longitudinal groove fulfilling used to compensate occurring stresses. Another function of the groove(s) is to provide conditions for air flow to ventilate the underfloor space, between the underside of the floor panel and the floor.

Also known from WO2022050891A1 is a method of making grooves in the underside of a panel element, such as a floor or wall panel made of thermoplastic material and filler. According to a method known in the art, the shaping of such a thermoplastic floor panel is performed at an elevated temperature and the shaped floor panel is then machined using rotary cutting tools or by planing with a non-rotary tool comprising one or more machining blades.

Also known from WO2020180237A1 is a method of making grooves in a floor panel, where the machined floor panel is in contact with a supporting element that secures this panel against uncontrolled changes of position. The formation of at least one groove is performed in the underside of the floor panel, by machining, using a rotary cutting tool comprising multiple blades.

### Aim of Invention

The aim of the invention is to develop a method of making grooves in the underside of floor panels that ensures increased efficiency, especially when simultaneously cutting multiple parallel grooves, with the inclined inner walls of each groove extending in the direction from the base of the panel to its interior, in particular dovetail, half dovetail or parallelogram grooves.

### SUMMARY OF INVENTION

In the method according to the invention, the parallel grooves in an underside of a floor panel are machined using a device with rotary machining units in the form of cutting heads. The floor panel is inserted between a lamellar retaining transport assembly and a lamellar pressing transport assembly. Then, the floor panel clamped between the lamellar retaining transport assembly and the lamellar pressing transport assembly is subjected to a feed motion through linear displacement. The cutting head is put into rotary motion around the axis of rotation, after which the parallel grooves are machined in the underside of the floor panel, using the sliding motion imparted to the floor panel by the lamellar retaining transport assembly and by the lamellar pressing transport assembly.

The solution is characterised by the machining of the parallel grooves in the underside of the floor panel being performed with the cutting head comprising a set of axially separated profile disc milling cutters having stepped variation of diameters, wherein the machining of the parallel grooves takes place with the axis of rotation of a spindle of the cutting head being inclined at an angle relative to the plane of the underside of the machined floor panel.

Preferably, the floor panel is imparted the feed motion through the lamellar retaining transport assembly and the lamellar pressing transport assembly using frictional lamellar elements.

Preferably, two spaced apart pressing transport assemblies are applied, with at least one cutting head located between these pressing transport assemblies.

Preferably, a stabilising element in the form of a pressing shoe is located between the separated pressing transport assemblies.

Preferably, the disc milling cutters used have inclined peripheral cutting edges which cut the bottoms of the grooves in parallel to the plane of the underside of the floor panel, with the angle of inclination of the peripheral cutting edges in relation to the axis of rotation of the cutting head being equal to the angle of inclination of the axis of rotation of the cutting head in relation to the underside of the machined floor panel.

Preferably, the used disc milling cutters are separated by spacers on the spindle of the cutting head.

Preferably, the milling of parallel grooves is performed as counter-rotating milling.

### Advantageous Effects of Invention

Machining parallel grooves using the cutting head comprising a set of axially spaced profiled disc milling cutters with stepped diameters, using an inclination of the spindle rotation axis of said cutting head relative to the plane of the underside of the floor panel to be machined, ensures fast and efficient machining. This type of milling is more efficient than planing or milling with shank cutters. It allows the use of automated machining lines, providing high-speed feeding of the machined floor panels, wherein the feed motion is imparted by the retaining transport assembly and the pressing transport assembly.

The positioning of the cutting head between the spaced apart pressing transport assemblies ensures stable positioning of the floor panel to be machined on the retaining transport assembly, thereby reducing vibrations and increasing machining accuracy.

The use of disc milling cutters in which the cutting edges that machine the groove bottoms are inclined at the angle equal to the inclination of the cutting head's axis of rotation relative to the plane of the underside of the floor panel to be machined, results in a surface of the bottom of the milled groove parallel to the plane of the underside of the machined floor panel.

The increased efficiency in cutting dovetail, half dovetail or parallelogram grooves on the underside of the floor panel makes construction of this type of structure economically justified, thereby increasing the possibilities of using a method of gluing the floor panels to the floor surface. This additional fixing method is particularly preferable in the case of floor panels made, among others, of wood, wood-based materials, mineral-synthetic or synthetic materials, which do not offer sufficient adhesive capacity in their material structure to form a permanent adhesive bond between the underside of the floor panel and the floor.

The shape of the groove in its cross-section, extending at least unilaterally towards its bottom, guarantees a permanent mechanical connection of the adhered floor panel to the substrate as a result of the solidification of the adhesive filling the shaped groove. As the adhesive fills the groove, it adapts to the shape of the groove in the floor panel, creating a permanent connection between the floor and the panel. At the same time, the adhesive joint creates a mechanical and chemical adhesive connection to the substrate, which is a preferable condition for this method of panels installation.

The grooves in the underside of the floor panels also facilitate ventilation of the underfloor space in case of snap-in floor installation. An additional advantage of using such grooves is that they neutralise the effects of possible material stresses within the longitudinal joint of floor panels joined or being joined. Cutting a groove on the underside of the floor panel in the zone of the snap-in elements improves the impact resistance of the material and the bending resistance of the groove lip. Of note is also that such panels can be mounted on floors or walls using flexible metal brackets or other fixing elements. Another important advantage of using such grooves is the reduction in the mass of the floor panels.

The method of imparting a feed motion to the floor panel, using the lamellar retaining transport assembly and the lamellar pressing transport assembly with the frictional lamellar elements, prevents the formation of static electricity on the surfaces of the machined floor panels and thus prevents the adverse phenomenon of chips adhering to the surfaces being machined. This method of imparting the feed motion reduces the likelihood of damage to the surface of the floor panels being moved due to the reduced possibility of slippage between the panels and the elements imparting the feed motion. Therefore, the possibility of local heating of the surface of the floor panels being transported, and consequently also the possibility of plastic deformation of such heated surfaces, is eliminated.

Spacing the pressing transport assemblies apart allows for the cutting heads to be located between the pressing transport assemblies, which increases the accuracy of the groove machining depth.

Further elimination of vibrations and an increase in the stability of the position of the machined floor panel relative to the cutting heads was achieved by locating a stabilising element in the form of the pressing shoe between the separated pressing transport assemblies.

The use of spacers between the disc milling cutters on the cutting head spindle makes it possible to achieve accurate spacing between the cutters and thus the right distance between the grooves being cut in the machined panels.

### BRIEF DESCRIPTION OF DRAWINGS

The subject of the invention is presented in embodiments in the drawing, in which:

FIG. 1 shows s a method of machining parallel grooves in the underside of the floor panel using a groove cutting device in its vertical version, in a top view;

FIG. 2a shows the method of FIG. 1, with the groove cutting device in an axonometric view;

FIG. 2b shows the method of machining parallel grooves in the underside of the floor panel using a groove cutting device in its horizontal version, in an axonometric view;

FIG. 3 shows the method of machining dovetail grooves;

FIG. 4 shows the method of machining half-dovetail grooves;

FIG. 5 shows the method of machining parallelogram grooves;

FIG. 6a shows the cutting head with the spindle inclined at the angle relative to the plane of the underside of the panel;

FIG. 6b shows one single cutter in a position perpendicular to the plane of the underside of the panel and a second single cutter, plunged into the panel, in its working position, as in FIG. 6a;

FIG. 6c shows a cross-section of the panel, with grooves cut in the parallelogram shape;

FIG. 7a shows the cutting head with the spindle inclined at the angle relative to the plane of the underside of the panel, opposite of FIG. 6a;

FIG. 7b shows one single cutter in a position perpendicular to the plane of the underside of the panel and a second single cutter, plunged into the panel, in its working position, as in FIG. 7a;

FIG. 7c shows a cross-section of the panel, with grooves cut in the dovetail shape;

FIG. 8a shows the cutting head with the spindle set in parallel to the plane of the underside of the panel;

FIG. 8b shows one single cutter in a position perpendicular to the plane of the underside of the panel and a second single cutter, plunged into the panel, in its working position, as in FIG. 8a;

FIG. 8c shows a cross-section of the panel, with grooves cut in

FIG. 9a shows the panel with grooves cut longitudinally in an axonometric view;

FIG. 9b shows a cross-section of the panel, with grooves cut in a dovetail shape, facing downwards;

FIG. 9c shows a cross-section of the panel, with grooves cut in a half-dovetail shape, facing downwards;

FIG. 9d shows a cross-section of the panel, with grooves cut in a parallelogram shape, facing downwards;

FIG. 9e shows a cross-section of the panel, with grooves cut in a parallelogram shape, facing downwards, in the direction opposite to that in FIG. 9d;

FIG. 10 shows a cross-section of a floor assembled from floor panels with grooves cut longitudinally.

### DESCRIPTION OF EMBODIMENTS

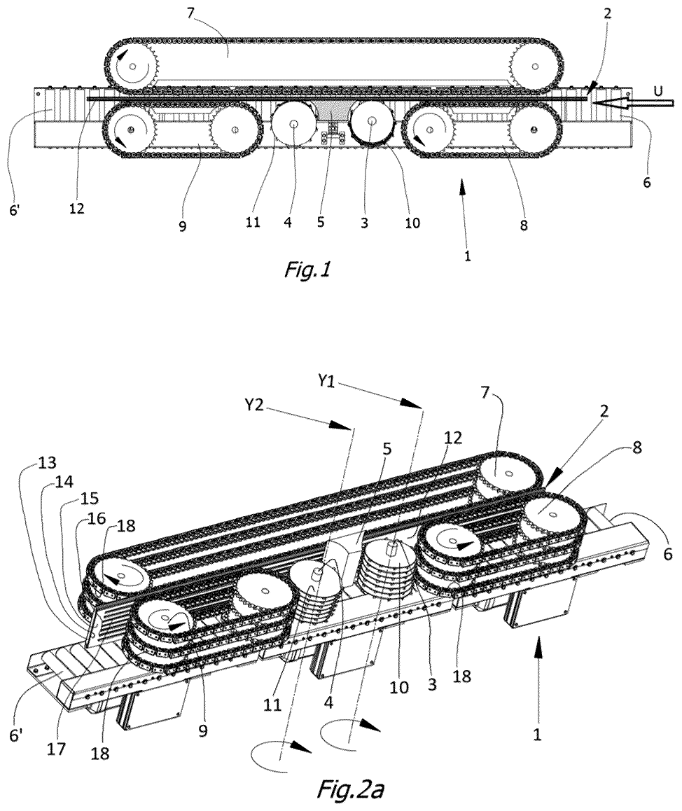

As shown in FIG. 1, a device 1 for cutting grooves in floor panels 2, in its vertical version, in a top view, is composed of a machining assembly consisting of two machining units 3, 4 and a stabilising element in the form of a pressing shoe 5. The second technical part of the device 1 is a transport assembly consisting of horizontal support rollers 6, 6′, maintaining a constant vertical position of the transported floor panels 2 in the groove-cutting device 1, and a lamellar retaining transport assembly 7, as well as a lamellar pressing transport assembly 8 located at the inlet of the device 1 and a lamellar pressing transport assembly 9 at the outlet of the device 1.

The transport assembly imparts a linear feed motion to the machined floor panels 2 in a U direction. The two machining units 3, 4 with mounted cutting heads 10, 11 are accommodated in the space between the lamellar pressing transport assemblies 8, 9. Behind the cutting head 11, the pressing shoe 5 is fitted. The floor panel 2 is inserted and clamped and fixed in the horizontal plane on the support rollers 6, 6′. During the transport of the floor panel 2 in the device 1, the machining units 3, 4 with the cutting heads 10, 11 mounted thereon perform a working movement on the underside 12 of the floor panel 2. The pressing shoe 5 is positioned in the free space between the cutting heads 10 and 11 and it presses the machined floor panel 2 against the lamellar retaining transport assembly 7, immediately after the floor panel 2 exits the working area of the cutting head 10 and before it enters the working area of the cutting head 11. By applying pressure in this way, the floor panel 2 being moved is stiffened, thus eliminating possible movement deviations during machining, which is a prerequisite for straight cutting of regular and repeated groove shapes.

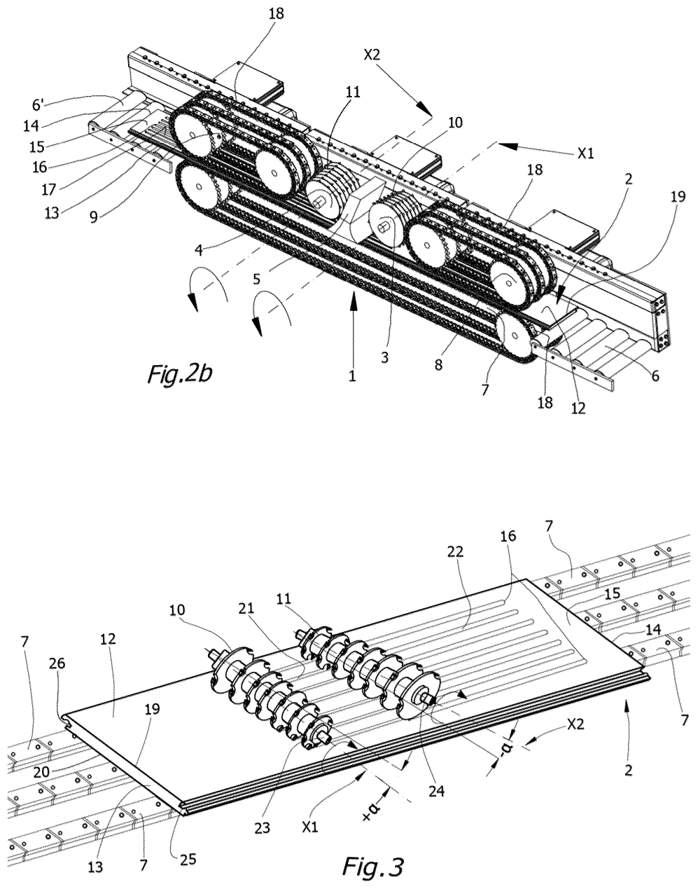

As shown in FIG. 2a, the floor panel 2 is inserted into the device 1 in a vertical position, so that the underside 12 of the core 13 of the floor panel 2 is positioned in front of the cutting heads 10, 11, keeping the edge 14 of the short side of the floor panel 2 perpendicular to the horizontal plane of the support rollers 6, 6′. By means of the support rollers 6, 6′, the floor panel 2 is transported into the area of operation of the clamping and feeding system, the base surface of which is the lamellar retaining transport assembly 7 and the clamping movable pressing side consists of the first lamellar pressing transport assembly 8 at the inlet of the device 1 and the second lamellar pressing transport assembly 9 at the outlet of the device 1. The floor panel 2 is clamped between the lamellar pressing transport assemblies 8, 9 and transported into the working area of the first machining unit 3, which automatically assumes the working position on its underside 12. Groove cutting starts automatically when the cutting head 10 is inserted into the core 13 of the floor panel 2 from its underside 12 at a strictly set distance from the edge 14 of the short side. The initial part of the underside of the floor panel 2 constitutes the first retaining and mounting surface 15, which reaches the boundary line 16 indicating the machining start point. From this boundary line 16, the first trace of the grooves to be cut is made by the cutting head 10, making a working movement around the axis of rotation Y1. Behind the cutting head 10, the floor panel 2 is seized by the pressing shoe 5. During the feed motion, the floor panel 2 leaves the working area of the pressing shoe 5, moving to the working area of the second tool head 11 performing a working movement around the axis of rotation Y2, giving the final planned shape to the grooves 17. After the machining operation, the transported floor panel 2, after being displaced beyond the head 11, is taken over by the lamellar pressing transport assembly 9 at the outlet of the device 1. The lamellar retaining transport assembly 7 and the lamellar pressing transport assemblies 8, 9 have integrated frictional lamellar elements 18 with non-slip properties with a considerable surface area adhering to the floor panels 2. This construction of the lamellar pressing transport assemblies 8, 9 enables the floor panels 2 to be clamped properly and exclude the possibility of slippage when the floor panels 2 are blocked, ensuring precision in determining the start and end point of the groove 17 cutting process.

In the groove cutting device 1, shown in FIG. 2b, in its horizontal version, the floor panel 2 is inserted into the device 1 in a lying position in which the underside 12 of the floor panel 2 is parallel to the horizontal plane defined by the support rollers 6, 6′. By means of the support rollers 6, the floor panel 2 is transported into the area of operation of the horizontal clamping and feeding system, the fixed side of which consists of the lamellar retaining transport assembly 7, and the movable side by the lamellar pressing transport assembly 8 at the inlet of the device 1 and the lamellar pressing transport assembly 9 at the outlet of the device 1.

The floor panel 2 is clamped between the lamellar retaining transport assembly 7 and the lamellar pressing transport assembly 8 at the inlet of the device and transported into the working area of the first machining unit 3 which automatically assumes the working position in the core 13 of the floor panel 2 on its underside 12. Having received the signal that the floor panel 2 has been inserted into the transport assembly, the cutting of the grooves 17 in the panel starts automatically at a strictly set distance from the edge 14 of the short side of the floor panel 2 when the cutting head 10 is inserted into the core 13 of the floor panel 2 below the plane of the underside 12. From the boundary line 16 indicating the machining start point, the first step of machining is performed by the cutting head 10, carrying out a working movement around the axis of rotation X1. Behind the cutting head 10, the floor panel 2 is seized by the pressing shoe 5 which presses the floor panel 2 down while allowing it to move with the lamellar retaining transport assembly 7. During the feed motion, the floor panel 2 leaves the working area of the pressing shoe 5, moving to the working area of the second machining unit 4, which, similarly to the first machining unit 3, assumes a working position in the core 13 of the floor panel 2 on its underside 12. After the second step of machining, the cutting head 11 performing a working movement around the axis of rotation X2 gives the final planned shape to the profile subject to machining. On the underside 12 of the floor panel 2, the area without grooves is the first lower retaining and mounting surface 15, which is contained between the edge 14 of the short side and the boundary line 16 indicating the machining start point. The lamellar retaining transport assembly 7 and the lamellar pressing transport assemblies 8, 9 on the contact surfaces with the floor panels 2 have built-in the frictional lamellar elements 18 with non-slip properties. Such a transport assembly protects against slippage, ensuring that the floor panels 2 are correctly positioned and that the start and end point of the machining process is precise in relation to the edge 14 of the short side and in relation to a the second edge 19 of the short side.

As shown in FIG. 3, the floor panel 2 is placed horizontally with its top side 20 on the lamellar retaining transport assembly 7. Prior to machining longitudinal grooves 21, 22, it is possible to produce lock profiles on the longitudinal edges of the floor panel 2 in the form of a mounting tongue 25 and a mounting groove 26 by means of cutting heads 10, 11 mounted on spindles 23, 24. The first cutting head 10, mounted on the first spindle 23, rotates with this spindle around its axis of rotation X1 inclined relative to the plane of the floor panel 2 at a positive angle +α, with the direction of machining being opposite to the direction of feed. The cutting head 10 plunges into the core 13 at a strictly set distance from the edge 14 of the short side and cuts the grooves 21. The place where the cutting head 10 is plunged into the core 13 of the floor panel 2 is the boundary line 16 indicating the start point of machining of the longitudinal grooves 21 in a parallelogram shape. The second cutting head 11, mounted on the second spindle 24, rotates around its axis of rotation X2 inclined relative to the plane of the floor panel 2 at a negative angle −α, while maintaining a counter-rotating direction of machining, and makes complementary cuts in the grooves 21, determining the final shape of the groove 22. The area without the cut grooves 21, 22, contained between the edge 14 of the short side and the boundary line 16 indicating the start point of machining, constitutes the first lower retaining and mounting surface 15. The cutting heads 10 and 11 producing the grooves 21, 22 end their working movement at the planned distance in front of the edge 19 of the short side, and the cutting heads 10, 11, together with the spindles 23, 24, are withdrawn automatically from the core 13 of the machined floor panel 2. The cutting of the grooves 21, 22 in sequentially transported panels 2 is performed in a similar manner. After being machined with the two cutting heads 10, 11 the grooves 22 have in cross-section a dovetail shape, i.e. an isosceles trapezoid.

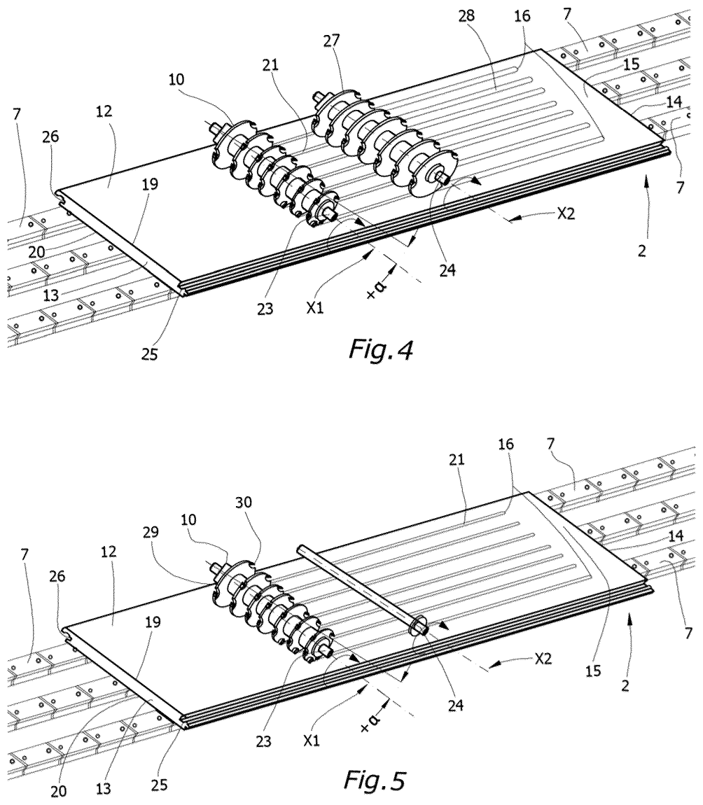

In another embodiment shown in FIG. 4, the grooves 21, 28 are machined in the floor panel 2 by means of the cutting heads 10, 27, on its underside 12 visible in the drawing. During the groove cutting process the floor panel 2 is placed horizontally with its top side 20 on the lamellar retaining transport assembly 7. Prior to the machining of the longitudinal grooves 21, 28, as in the example shown in FIG. 3, it is possible to produce lock profiles in the form of the mounting tongue 25 and the mounting groove 26 on the longitudinal edges of the floor panel 2. The first cutting head 10, mounted on the spindle 23, rotates around its axis of rotation X1 inclined relative to the plane of the floor panel 2 at the positive angle +α, with the direction of machining being opposite to the direction of the feed. The cutting head 10, at a strictly set distance from the edge 14 of the short side, plunges into the core 13 and cuts the grooves 21. The location where the cutting head 10 is plunged into the core 13 of the floor panel 2 is the start point for cutting the grooves 21, the cross-section of which has a parallelogram shape. The machining tools mounted on the cutting head 10 have variable diameters. Meanwhile the machining tools mounted on the spindle 24 of the cutting head 27 have equal machining radii and are mounted in a horizontal position, parallel to the underside 12 of the floor panel 2. During the working movement, the cutting head 27 rotates with the spindle 24 around its axis of rotation X3 with a counter-rotating machining direction, making complementary cuts in the previously cut grooves 21, establishing the final cross-sectional shape of the grooves 28 in the form of a half-dovetail, i.e. a rectangular trapezoid. The area without cut grooves, contained between the edge 14 of the short side and the boundary line 16 indicating the machining start point, constitutes the first lower retaining and mounting surface 15. The cutting heads 10 and 27 producing the grooves 21, 28 end their working movement at the planned distance in front of the edge 19 of the short side, followed by withdrawing these heads from the machined floor panel 2.

In another embodiment shown in FIG. 5, the method of cutting the grooves 21 in the core 13 of the floor panel 2, on its visible underside 12, by means of one cutting head 10, is shown. While cutting the grooves 21 the floor panel 2 is placed horizontally with its top side 20 on the lamellar transport assembly 7. Before cutting the grooves 21, lock profiles in the form of the mounting tongue 25 and the mounting groove 26 were made on the longitudinal edges of the floor panel 2. The cutting head 10, mounted on the spindle 23, rotates around its axis of rotation X1 inclined relative to the level of the floor panel 2 at the positive angle +α, with the direction of machining being opposite to the direction of the feed motion. The cutting head 10, at a strictly set distance from the edge of the short side 14, plunges into the core 13 of the floor panel 2 and cuts the grooves 21 with a parallelogram cross-section. The area without cut grooves, contained between the edge 14 of the short side and the boundary line 16 indicating the machining start point, constitutes the first lower retaining and mounting surface 15. Milling cutters 29 with cutting tooth 30 mounted on the cutting head 10 have variable diameters, which is a prerequisite for obtaining the grooves 21 with their walls inclined relative to the plane of the underside 12 of the floor panel 2. The area without the cut grooves 21, contained between the edge 14 of the short side and the boundary line 16 indicating the machining start point, constitutes the first lower retaining and mounting surface 15. The cutting head 10 in the final step of cutting the grooves 21 withdraws automatically from the floor panel 2 at the planned distance in front of the edge 19 of the short side. The grooves 21 have a parallelogram shape in cross-section after being cut with one cutting head 10. The spindle 24, meanwhile, is not involved in groove cutting and is in standby.

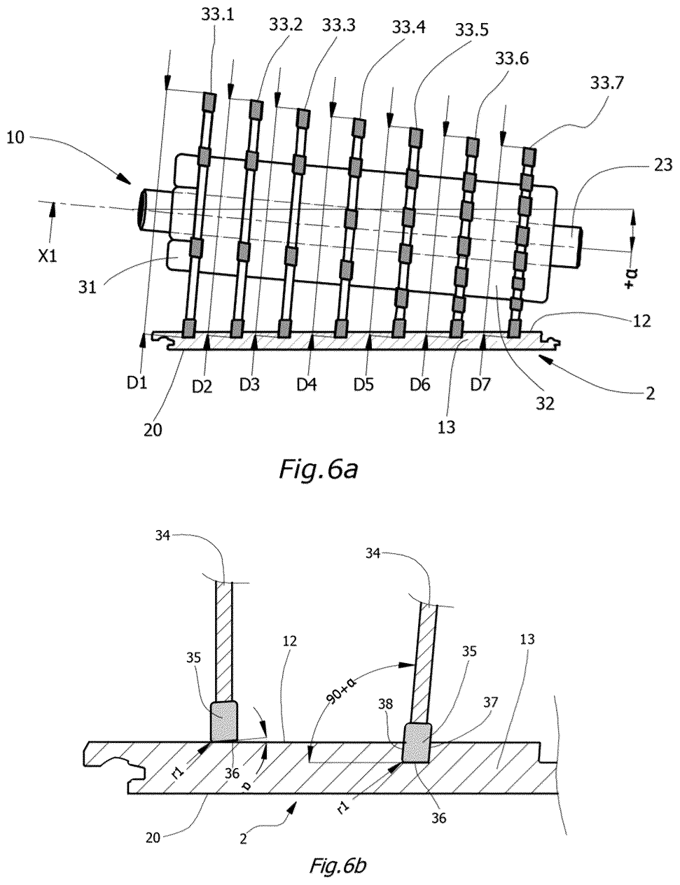

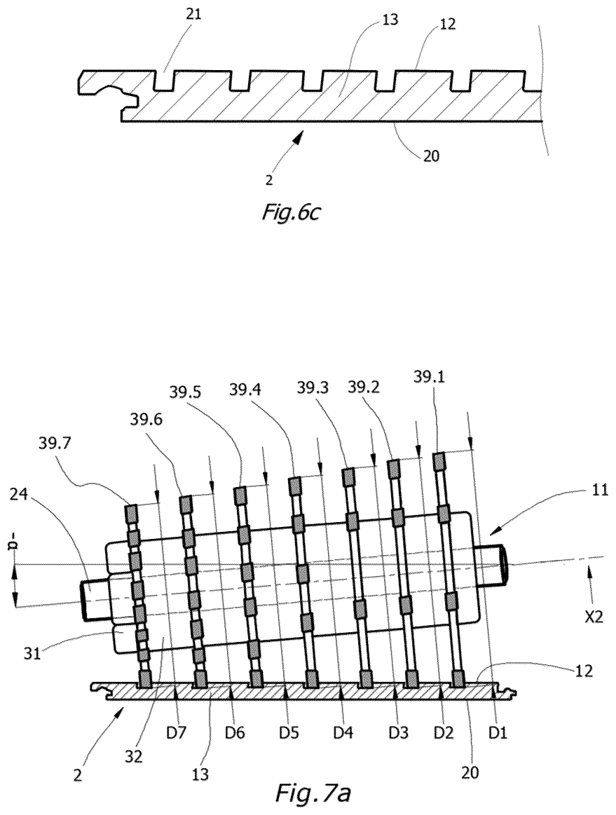

The complete cutting head 10 is shown in an embodiment in FIG. 6a. The cutting head 10 has a mounting sleeve 31 with spacers 32 mounted on the spindle 23. The machining tools mounted on the cutting head 10 have the form of cutters 33.1, 33.2, 33.3, 33.4, 33.5, 33.6, 33.7 with gradually changing diameters D1, D2, D3, D4, D5, D6, D7, ranging from 150 to 210 mm. The thickness of the spacers 32 determines the distance between the adjacent edges of the grooves 21 cut in the core 13 of the underside 12 of the floor panel 2. The spindle 23 with the mounted cutting head 10 has its axis of rotation X1 inclined at the positive angle +α relative to the plane of the underside 12 of the machined floor panel 2.

The cutters 33. 1, 33.2, 33.3, 33. 4, 33.5, 33.6, 33.7 with gradually changing diameters D1, D2, D3, D4, D5, D6, D7, have disc-shaped bodies 34 with teeth 35 with peripheral cutting edges 36 inclined at the angle α, as shown in FIG. 6b, whereby the peripheral cutting edges 36, at the point of contact with the underside 12 of the floor panel 2, remain parallel to its plane. With this configuration, the cutting head 10 machines the grooves 21 with a parallelogram cross-section.

In FIG. 6b there is a schematic illustration of a single machining tool in the form of the cutter 33.1 seated in the cutting head 10, shown in FIG. 6a. For a better illustration of the structure, the disc-shaped body 34 of the cutter 33.1 is shown in FIG. 6b on the left, in a position perpendicular to the plane of the underside 12 of the floor panel 2. The correct working position of the body 34 of the cutter 33.1 is shown on the right. Each tooth 35 has the peripheral cutting edge 36 and two lateral cutting edges 37, 38, whereby an oval of radius r1 is formed at the intersection of the lateral cutting edge 38 with the peripheral cutting edge 36. The teeth 35 of the cutter 33.1, as well as of the other cutters 33.2, 33.3, 33.4, 33.5, 33.6, 33.7, shown in FIG. 6a, have machining blades with a one-sided right oblique cut at the angle α. The cutter in the working position is plunged into the core 13 from the underside 12 of the floor panel 2.

The shape of the grooves 21, cut on the underside 12 in the core 13 of the floor panel 2 by means of the cutting head 10 illustrated in FIG. 6a, is shown in FIG. 6c. The grooves have a parallelogram shape in their cross-section after being cut with this cutting head 10.

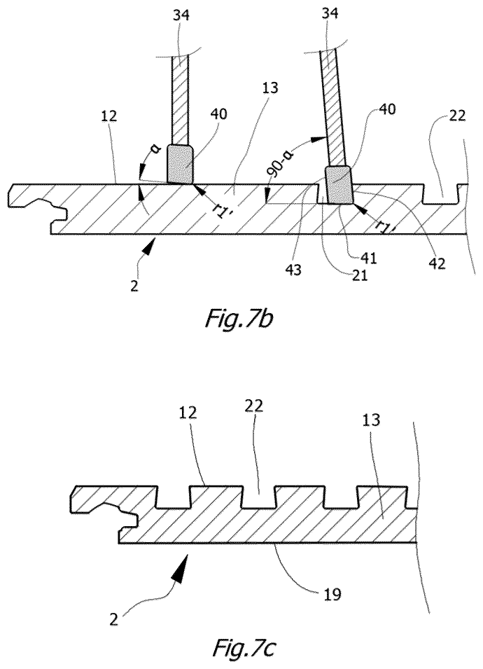

The complete cutting head 11 is shown in an embodiment in FIG. 7a. The cutting head 11 has a mounting sleeve 31 with spacers 32 mounted on the spindle 24. The machining tools mounted on the cutting head 11 have the form of cutters 39.1, 39.2, 39.3, 39.4, 39.5, 39.6, 39.7 with gradually changing diameters D1, D2, D3, D4, D5, D6, D7 in the range of 150 to 210 mm and are mounted on the mounting sleeve 31, and separated by the spacers 32, the thickness of which determines the distances between the adjacent edges of the cut grooves 22 in the core 13 of the underside 12 of the floor panel 2. The spindle 24 with the mounted cutting head 11 has its axis of rotation X2 inclined at the negative angle −αrelative to the plane of the underside 12 of the machined floor panel 2.

The cutters 39. 1, 39.2, 39. 3, 39.4, 39.5, 39.6, 39.7 with gradually changing diameters D1, D2, D3, D4, D5, D6, D7, have disc-shaped bodies 34 with teeth 40, the teeth 40 having peripheral cutting edges 41 inclined at the angle α, as shown in FIG. 7b, whereby these peripheral cutting edges 41, at the point of contact with the underside 12 of the floor panel 2 which faces with its top side 20 towards the underside, remain parallel to this underside 12, due to the inclination of the spindle at the negative angle −α. With this configuration, the cutting head 11 machines the grooves 22 with a parallelogram cross-section.

In FIG. 7b, there is a schematic illustration of a single machining tool in the form of the cutter 39.1 seated in the cutting head 11 shown in FIG. 7a. For a better illustration of the structure, the disc-shaped body 34 of the cutter 39.1 is shown in FIG. 7b on the left, in a position perpendicular to the underside 12 of the floor panel 2. The correct working position of the cutter 39.1 is shown on the right, where the cutter 39.1 is inclined relative to the underside 12 of the floor panel 2 at the angle of 90−α. The same inclination of the cutter 39.1 occurs with respect to the lower surface of the cut groove 21 as this lower surface of the groove 21 is parallel to the underside 12 of the floor panel 2. Each tooth 40 has the peripheral cutting edge 41 and two lateral cutting edges 42, 43, whereby an oval of radius rl′ is formed at the intersection of the lateral cutting edge 42 with the peripheral cutting edge 41. The teeth 40 of the cutter 39.1, as well as of the other cutters 39.2; 39.3; 39.4; 39.5; 39.6; 39.7, shown in FIG. 7a, have machining blades with a one-sided left oblique cut inclined at the angle α. The cutter 39.1 in the working position is plunged into the core 13 from the underside 12 of the floor panel 2 in order to give the final shape to the previously cut groove 21. The second lateral cutting edge 43 of the tooth 40 is not involved in the machining. The cross-section of the grooves 22 milled by the two cutting heads 10 and 11 has the shape of an isosceles trapezoid.

The shape of the grooves 22 cut in the core 13, on the underside 12 of the floor panel 2, by means of the cutting heads 10 and 11 illustrated in FIGS. 6a and 7a, is shown in FIG. 7c. The grooves 22 cut with these cutting heads 10, 11 have the shape of an isosceles trapezoid in cross-section.

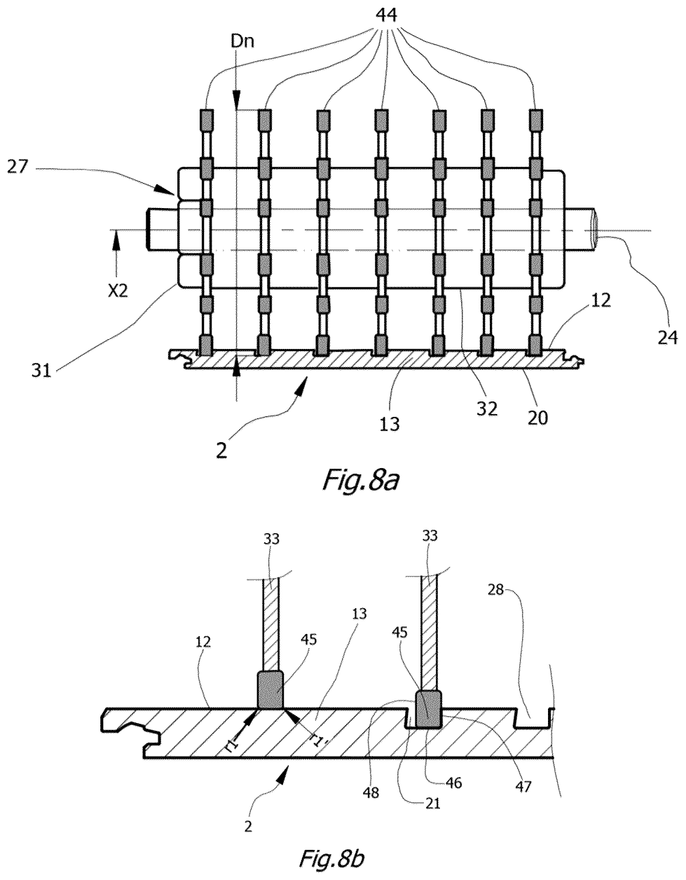

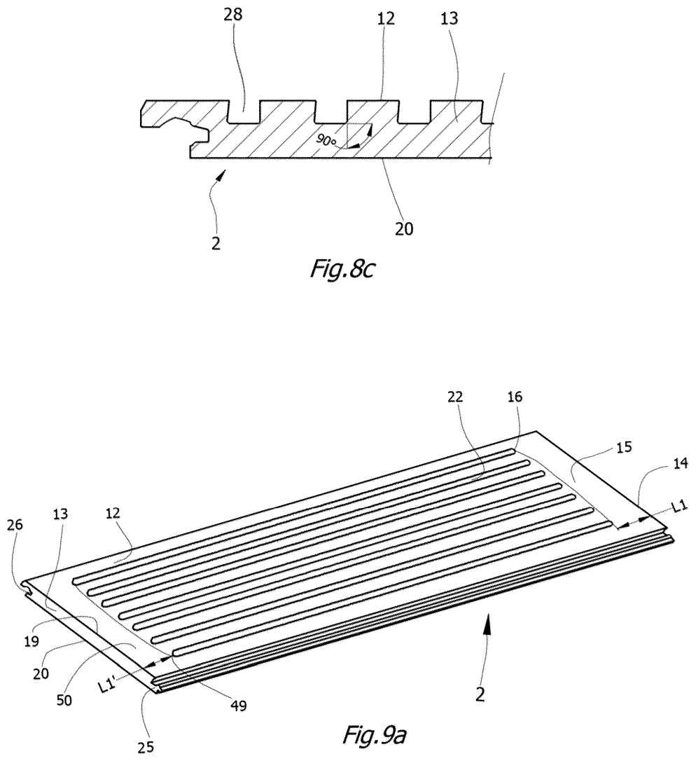

The cutting head 27, shown in an embodiment in FIG. 8a, has the mounting sleeve 31 with the spacers 32 mounted on the spindle 24. The machining tools mounted on the cutting head 27 are in the form of cutters 44 of equal diameter D=210 mm. The cutters 44 are mounted in the mounting sleeve 31 and divided by the spacers 32, the thickness of which establishes the distances between the adjacent edges of the cut grooves 28 in the core 13 of the underside 12 of the floor panel 2. The axis of rotation X3 of the spindle 24 with the cutting head 27 installed is parallel to the plane of the underside 12 of the floor panel 2. As shown in FIG. 8b, the teeth 45 of the cutters 44 have a straight cut and a rectangular shape.

FIG. 8b shows a single machining tool in the form of the cutter 44 seated in the cutting head 27 shown in FIG. 8a. For a better illustration of the structure, the disc-shaped body 34 of the cutter 44 is shown in FIG. 8b on the left, in a position in contact with the underside 12 of the floor panel 2. The working position of the cutter 44 is shown on the right, where the cutter 44 is plunged into the groove 21. Once the cutter 44 has passed, the groove 21 takes the form of groove 28. Each tooth 45 of the cutter 44 has a peripheral cutting edge 46 and two lateral cutting edges 47, 48, whereby the ovals of radii r1′, r1 are formed at the intersection of the lateral cutting edges 47, 48 with the peripheral cutting edge 46. The teeth 45 of the cutter 44 are rectangular in shape. The cutter 44 in the working position is plunged into the core 13 from the underside 12 of the floor panel 2 in order to make a rectangular cut of the groove 28. In this case the second lateral cutting edge 48 of the tooth 44 is not involved in the machining. The cross-section of the grooves 28 milled by the two cutting heads 10 and 27 has the shape of a rectangular trapezoid.

The floor panel 2 with the grooves 28 cut in one working pass in the device 1, by means of the two cutting heads 10 and 27, is shown in FIG. 8c. The grooves 28 have the shape of a rectangular trapezoid in cross-section and are cut in the core 13 on the underside 12 of the floor panel 2.

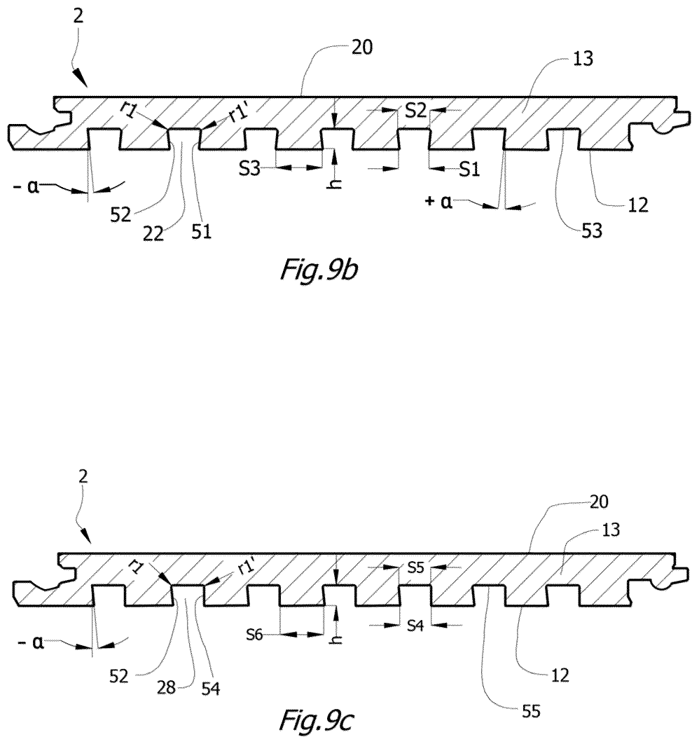

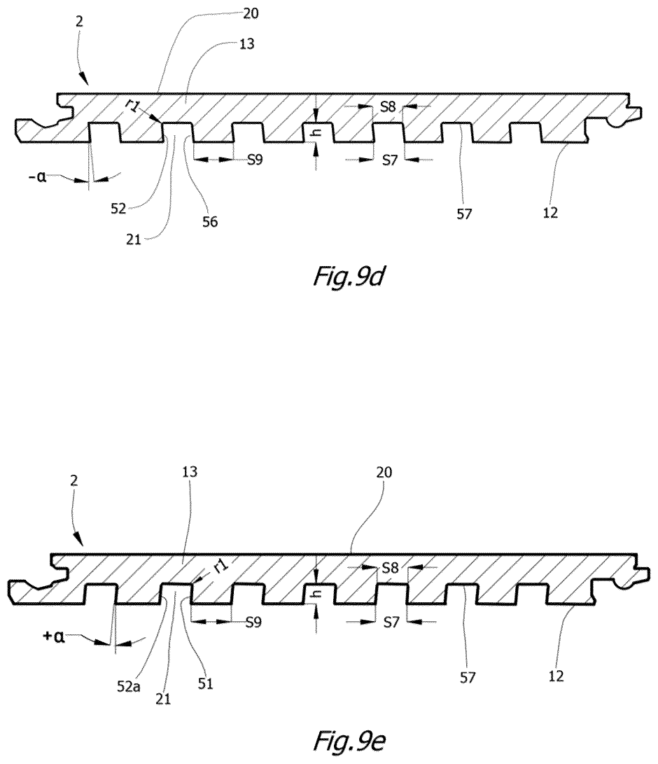

FIG. 9a shows the floor panel 2 with its top side 20 facing downwards, with the cut longitudinal grooves 22 in the core 13 on its visible underside 12, as those shown in FIG. 7c. The grooves 22 have the shape of an isosceles trapezoid in cross-section. Between the boundary line 16 indicating the start point of machining of the grooves 22 and the edge 14 of the first short side, an uncut area is formed, covering the area with a length L1, which is the first lower retaining and mounting surface 15 of the floor panel 2. The boundary line 49 indicating the end of machining the grooves 22 is separated from the edge 19 of the second short side and thus defines the second uncut area with a length L1′, which is the second retaining and mounting surface 50.

The floor panel 2 with the grooves cut in a dovetail shape, with its top side 20 facing upwards is shown in FIG. 9b. The cut grooves 22 are in the shape of an isosceles trapezoid with a right sidewall 51 having the positive inclination angle +α and a left sidewall 52 having the negative inclination angle −α. The bottom 53 of the groove 22, at the points of contact with its sidewalls 51 and 52, has ovals of radii r1′, r1, increasing the bending strength of the floor panels 2. The cut grooves 22 have an outer width S1, an inner width S2 and a groove height h. A spacing S3 between the sidewalls 51 and 52 of the adjacent grooves 22 on the outer side is: S3≥1.5 ×S1. In the embodiment shown in FIG. 9b, for the floor panels with a thickness of 6 mm, the dimensional parameters ensuring sufficient strength of the floor panels under typical use are: α=±9; S1 =4 mm; S2 =5 mm; S3 =6 mm; h=3 mm.

The floor panel 2 with the grooves cut in a half-dovetail shape, with its top side 20 facing upwards, is shown in FIG. 9c. The cut grooves 22 have the shape of a rectangular trapezoid in cross-section with a perpendicular sidewall 54 and the left sidewall 52 with the negative inclination angle −α. The bottom of the groove 55, at the contact with its sidewalls 54 and 52, has ovals of radii r1, r1′, increasing the bending strength of the floor panels 2. The cut grooves 28 have an outer width S4, an inner width S5 and a height h. A spacing S6 between the sidewalls 54 and 52 of the adjacent grooves 28 is: S6≥1.5 ×S4. In the embodiment shown in FIG. 9c, for the floor panels 2 with a thickness of 6 mm, the dimensional parameters ensuring sufficient strength of the floor panels 2 under typical use are: α=−9° ; S4=4.5 mm; S5 =5 mm; S6 32 7 mm; h=3 mm.

FIG. 9d shows the floor panel 2 with its top side 20 facing upwards. On the underside 12 in the core 13 of the floor panel 2 there are grooves 21 cut in the shape of a parallelogram in cross-section with the left sidewall 52 and the right sidewall 56 with the negative inclination angle −α. With equal inclination angles −α, the sidewalls 52 and 56 remain parallel to each other. The bottom of the groove 57, at the point of contact with the sidewall 52, has an oval of radius r1, increasing the bending strength of the floor panels 2. The cut grooves have an outer width S7, an inner width S8, with S7=S8, and the groove height h. A spacing S9 between the sidewalls of the adjacent grooves 21 is: S9≥1.5 ×S7. In the embodiment shown in FIG. 9d, for the floor panels 2 with a thickness of 6 mm, the dimensional parameters ensuring sufficient strength of the floor panels 2 under typical use are: α=−9°; S7=3.5 mm; S8=3.5 mm; S9=6 mm; h=3 mm.

FIG. 9e shows the panel with grooves cut in a parallelogram shape, facing downwards, in the direction opposite to that in FIG. 9d. For the floor panels 2 with a thickness of 6 mm, the dimensional parameters ensuring sufficient strength of the floor panels 2 under typical use are: α=+9°; S7=3.5 mm; S8=3.5 mm; S9=6 mm; h=3 mm.

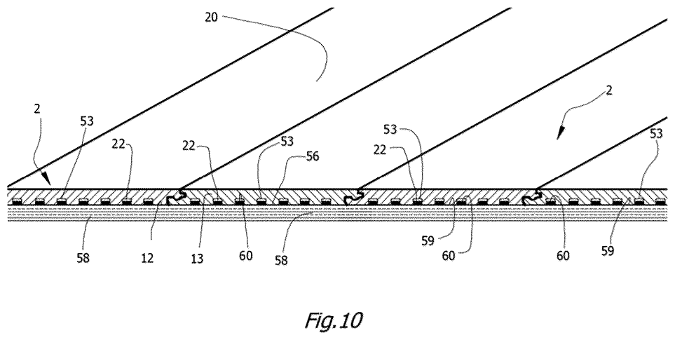

FIG. 10 shows the floor panels 2 mounted on the floor by gluing to the flooring 58. There is an adhesive joint 59 between the flooring 58 and the laid floor panels 2, while the profiles of the grooves 22 are filled with a solidified adhesive compound in the form of adhesive fins 60, mimicking the shape of the grooves 22. This results in a mechanical connection between the floor panel 2 and the dovetail flooring, where the expanded and solidified adhesive fin 60 forms a joint with the cut groove 22, increasing the positional stability of the floor panel 2 relative to the flooring 58.

The machining method according to the embodiment can be implemented by means of the device 1 in its vertical version, as shown in FIG. 1 and FIG. 2a, or the device 1 in its horizontal version, as shown in FIG. 2b, FIG. 3, FIG. 4, FIG. 5, FIG. 6a, FIG. 7a, FIG. 8a. The device 1 has a transport assembly with horizontal support rollers 6, 6′, a lamellar retaining transport assembly 7, a lamellar pressing transport assembly 8 at the inlet of the device 1 and a second lamellar pressing transport assembly 9 at the outlet of the device 1. There is also a machining assembly with two independent machining units 3, 4, in the form of cutting heads 10, 11, built into the structure of the device 1. In the space between the cutting heads 10, 11, a pressing shoe 5 is built in, which presses the machined floor panel 2 against the lamellar retaining transport assembly 7, maintaining a linear transport path during machining. The machining units 3, 4 have an adjustable distance and angle position relative to the underside 12 of the floor panel 2, so that it is possible to set both the inclination angles +α,−α of the axis of rotation X1, X2 of the spindles 23, 24 of the cutting heads 10, 11 for the horizontal version of the device 1 or the inclination of the axis of rotation Y1, Y2 for the vertical version of the device 1. Angular adjustment of the position of the units 3, 4 is an essential condition for achieving the objectives of the method according to the invention. By giving the inclination angles a to the axes of rotation X1, X2; Y1, Y2 of the spindles of the cutting heads 10, 11, parallel grooves 17, 21, 22 are obtained in the underside 12 of the floor panel 2, with the sidewalls 51, 52, 56 inclined at the same angle +α, −αrelative to the plane of this underside 12, as shown in FIG. 9b,

In an embodiment according to the invention, the cut parallel grooves 17, 21, 22, 28 have bottoms 53, 55, 57 parallel to the plane of the underside 12 of the floor panel 2. As shown schematically in FIG. 6b, FIG. 7b, this feature was achieved by inclining at the angle α the peripheral cutting edges 36, 41 of the teeth 35, 40 integrated with the disc-shaped bodies 34, so that these peripheral cutting edges 36, 41 at the point of contact with the underside 12 of the floor panel 2 remain parallel to its plane.

The cutting of the parallel grooves 17, 21, 22, 28 in the underside 12 of the floor panel 2 in a vertical arrangement is shown in FIG. 1 and FIG. 2a, and in a horizontal arrangement is shown in FIG. 2b, FIG. 3, FIG. 4, FIG. 5, FIG. 6a, FIG. 7a, FIG. 8a.

In the first step, the floor panel 2 is inserted between the lamellar retaining transport assembly 7 and the lamellar pressing transport assembly 8, 9. Then, the floor panel 2, clamped between the lamellar retaining transport assembly 7 and the lamellar pressing transport assembly 8, 9 is subjected to a feed motion through linear movement. For this purpose, frictional lamellar elements 18 with non-slip properties are used to counteract the blocking of the floor panels 2 during the feed motion and any deviation from the linear feed direction. The cutting head 10, 11, 27 is put into a rotary motion around the axes of rotation X1, X2; Y1, Y2 and the parallel grooves 17, 21, 22, 28 are machined in the underside 12 of the floor panel 2, using the feed motion imparted to it by the lamellar retaining transport assembly 7 and by the lamellar pressing transport assembly 8, 9.

Simultaneous machining of the multiple parallel grooves 17, 21, 22, 28 in the underside 12 of the floor panel 2 is performed with the cutting head 10, 11, 27, containing an assembly of axially separated profile disc cutters 33.1, 33.2, 33.3, 33.4, 33.5, 33.6, 33.7, as shown in FIG. 6a, or disc cutters 39.1, 39.2, 39.3, 39.4, 39.5, 39.6, 39.7, as shown in FIG. 7a. The said disc cutters have gradually changing diameters D1, D2, D3, D4, D5, D6, D7, whereby the machining of the parallel grooves 17, 21, 22 is performed with the inclination of the axes of rotation X1, X2; Y1, Y2 of the spindles 23, 24 of the cutting head 10, 11 relative to the plane of the underside 12 of the machined floor panel 2 at the angle +α, as shown in FIG. 6a, or at the angle −α, as shown in FIG. 7a.

In an embodiment of the method of machining parallel grooves in the underside of the floor panel 2 using the groove cutting device in its vertical version, as shown in FIG. 1 and FIG. 1a, the machining units 3, 4 and the lamellar pressing transport assemblies 8, 9 are positioned in the vertical plane. Also, the machined floor panel 2 is laid with the wide plane of its underside 12 vertically. The edge of the long side of the transported floor panel 2 rests on the support rollers 6, 6′, located horizontally in the device 1. The cutting head 10 performs a rotary movement about the axis of rotation Y1 and the cutting head 11 performs a rotary movement about the axis of rotation Y2, the direction of machining being opposite to the direction of feed of the panels 2. The vertical version of the device 1 is a compact structure made of similar components to the horizontal version of device 1 with the same principle of operation and execution of the machining operations for the floor panel 2. In an embodiment of the method of machining parallel grooves in the underside of the floor panel 2 using the groove cutting device in its horizontal version, as shown in FIG. 2b and FIG. 3, the cutting heads 10 and 11 perform a rotary movement around the axes X1 and X2, with the machining direction being opposite to the feed direction of the transported floor panels 2.

As shown in FIG. 2b, after passing the working area of the cutting heads 10, 11, the moved floor panel 2 enters the working area of the pressing shoe 5, which exerts a pressure on the underside 12 of the floor panel 2, pressing the floor panel 2 against the base, which is the lamellar retaining transport assembly 7. Directly from the working area of the pressing shoe 5, the transported floor panel 2 moves to the working area of the second machining unit 4 with the mounted cutting head 11, which performs a rotary movement around the axis of rotation X2, widening the grooves 17 previously cut by the cutting head 10, giving them the required dimensions and shape in cross-section. After cutting the grooves 17, the moved floor panel 2 enters the area of the lamellar pressing transport assembly 9, which presses the machined floor panel 2 against the lamellar retaining transport assembly 7, moving it towards the outlet side of the device 1 with the horizontal receiving support rollers 6′. As shown in FIG. 9a, the area without the cut grooves 22, contained between the edge 14 of the short side and the boundary line 16 indicating the start point of groove cutting, constitutes the first lower retaining and mounting surface 15.

The cutting heads 10, 11 or 27 consist of a sleeve 31 with seated profile disc cutters 29, 33.1 to 33.7, 39.1 to 39.7, 44, divided by spacers 32 which adjust the spacing between the cutters and thus the distance between the cut grooves 17, 21, 22, 28 in the machined floor panels. Each profile disc cutter in the cutting head 10 or 11 set at the inclination angle +α, −α respectively, has diameters gradually changing from D1 to D7. Therefore, each of the cutters in the cutting heads 10 and 11 has a different machining speed and may have a different number of machining blades. A common parameter for the machining cutter assembly is the thickness of the machined layer.

The structure of the device 1 for cutting grooves 17, 21, 22, 28, allows to install independent cutting heads 10, 11 or 27 with the possibility of adjusting their angle of inclination a relative to the plane of the machined panel. The cutting heads 10 and 11 have cutters with a variable diameter D, while the cutting head 27 comprises cutters with a uniform diameter D and is used to profile the grooves 28 with a rectangular trapezoid cross-section, with the grooves 21 cut previously with the cutting head 10. The machining assembly of the cutting heads 10 and 11 profiles the grooves 22 with an isosceles trapezoid cross-section, also known as a dovetail type, while the use in the machining process of the single cutting head 10 or 11 profiles the grooves 21 with a parallelogram cross-section.

### EXAMPLES

### Example 1

Machining grooves with an isosceles trapezoid shape Grooves with an isosceles trapezoid shape, also known as of dovetail type, are made with two machining units 3, 4 with mounted cutting heads 10 and 11, as shown in FIG. 1, FIG. 2a, FIG. 2b and FIG. 3. For this purpose, the cutting head 10 is used, shown in FIG. 6a, equipped with a set of cutters 33.1, 33.2, 33.3, 33.4, 33.5, 33.6, 33.7 with variable diameters D1, D2, D3, D4, D5, D6, D7, mounted on the spindle 23 inclined at the angle +α relative to the plane of the lamellar retaining transport assembly 7 and simultaneously relative to the plane of the underside 12 of the floor panel 2. Thus, multiple parallel grooves 21 are cut, as shown in FIG. 6c, with a cross-section in the shape of a parallelogram.

Then, the cutting head 11 is used, shown in FIG. 7a, equipped with a set of cutters 39.1, 39.2, 39.3, 39.4, 39.5, 39.6, 39.7 with variable diameters D1, D2, D3, D4, D5, D6, D7, mounted on the spindle 24, this spindle 24 being inclined at the angle −α relative to the plane of the lamellar retaining transport assembly 7 and simultaneously relative to the plane of the underside 12 of the floor panel 2. Grooves 22 are thus cut, as shown in FIGS. 7c and 9b, complementing the previously made grooves 21. Such a complemented groove 22 has the shape of an isosceles trapezoid.

The inner width S2 of the bottom of each groove 22 is larger than its outer width S1 on the underside 12 of the floor panel 2. The height h of the cut groove is adjusted by the size of the plunge of the two machining units 3 and 4.

### Example 2

Machining grooves of rectangular trapezoid shape The grooves of rectangular trapezoid shape, also known as of half-dovetail type, are made with two machining units 3, 4 with the mounted cutting heads 10 and 27, as shown in FIG. 1, FIG. 2a, FIG. 2b and FIG. 4. First, the cutting head 10 is used, shown in FIG. 6a, equipped with a set of cutters 33.1, 33.2, 33. 3, 33.4, 33.5, 33.6, 33.7 with variable diameters D1, D2, D3, D4, D5, D6, D7, mounted on the spindle 23 inclined at the angle +α relative to the plane of the lamellar retaining transport assembly 7 and simultaneously relative to the plane of the underside 12 of the floor panel 2. Thus, multiple parallel grooves 21 are cut, as shown in FIG. 6c, with a cross-section in the shape of a parallelogram.

Then, using the machining unit 4 with the cutting head 27, shown in FIG. 8a, with the uniform diameter D of the cutters 44 with the horizontal position of the axis of rotation X3 of the spindle 24, the final shape of the groove 28 is established, as shown in FIG. 8c and FIG. 9c. The sidewall 54 of the groove 28 thus formed is perpendicular to the plane of the underside 12 of the floor panel 2 and the bottom 55 of the cut groove 28. The inner width S5 of the bottom 55 of the groove 28 is larger than the outer width S4 of the groove 28 cut on the plane of the underside 12 of the floor panel 2. The height h of the cut grooves, similar to Example 1, is adjusted by the size of the plunge of the two machining units 3, 4.

### Example 3

Machining parallelogram-shaped grooves The parallelogram-shaped grooves 21 are made with the first machining unit 3 with the cutting head 10 mounted. The grooves 21, as shown in FIG. 6c and FIG. 9d, have their outer width S7 equal to their inner width S8, while the sidewalls 52, 56 of the grooves 21 have the same inclination angle −α relative to the plane of the bottom 57 and the plane of the underside 12 of the floor panel 2. The height h of the cut grooves is adjusted by the size of the plunge of the machining unit 3 relative to the underside 12 of the floor panel 2.

When the grooves are cut with the second machining unit 4, with the cutting head 11 mounted, without involvement of the machining unit 3, using the cutting head 11, the groove 21 with a parallelogram cross-section is obtained with the equal widths S7 and S8 of the groove 21 with the inclination angle +α of its sidewalls 52a, 51, as shown in FIG. 9e.

In an optional embodiment of the solution according to the invention, grooves 17, 21, 22, 28, the mounting tongue 25 is cut on one of the long sides of the floor panel 2 and the mounting groove 26 is cut on the other long side. The grooves 17, 21, 22, 28 which are cut next are parallel to the profiles of the mounting tongue 25 and the mounting groove 26 on the long sides of the floor panel 2.

Different versions of the cutting heads 10, 11, 27 are used to cut the grooves 17, 21, 22, 28. The complete cutting head 10 includes the mounting sleeve 31 with the spacers 32 with machining tools mounted. The thickness of the spacers 32 determines the distance between the adjacent edges of the cut grooves 17, 21, 22, 28.

The cutters 33. 1, 33.2, 33. 3, 33. 4, 33.5, 33.6, 33.7 of the cutting head 10 with gradually changing diameters D1, D2, D3, D4, D5, D6, D7 have teeth 35 built in on the periphery of the bodies 34, wherein in each successive cutter from the set of cutters 33.1, 33.2, 33. 3, 33.4, 33.5, 33.6, 33.7, the diameter is reduced and the number of the built-in teeth 35 is adjusted, the said number determining the similar thickness of the layer machined by the teeth 35 regardless of the cutter diameter.

An analogous principle applies to the use of the cutting head 11 with the mounting sleeve 31 and the spacers 32 with mounted machining tools in the form of the cutters 39.1; 39.2; 39.3; 39.4; 39.5; 39.6; 39.7 with gradually changing diameters D1, D2, D3, D4, D5, D6, D7. Here, the diameter is also reduced and the number of built-in teeth 40 is adjusted, the said number determining the similar thickness of the layer machined by the teeth 40 regardless of the cutter diameter.

The Process of Cutting the Grooves 21, 22 in the Floor panel 2 starts with the insertion of the floor panel 2 into the working area of the machining unit 3 with the mounted cutting head 10, as shown in FIG. 2b and FIG. 3. The working surface of the cutting head 10 is positioned in a horizontal plane directly above the lamellar retaining transport assembly 7, the height of the gap between the lamellar retaining transport assembly 7 and the working surface of the head being 1 mm larger than the thickness of the machined floor panel 2. After the edge 14 of the short side of the floor panel 2 has crossed the axis X1 of the spindle 23 of the machining unit 3, this unit plunges towards the underside 12 of the floor panel 2 with the plunge of the teeth 35 of the cutters 33.1, 33.2, 33.3, 33.4, 33.5, 33.6, 33.7 in the core 13 to a depth corresponding to the height h of the cut grooves 21, 22, starting the cutting of these grooves from the boundary line 16, establishing the length L1 of the first lower retaining and mounting surface 15, as shown in FIG. 9a. The transported floor panel 2, performing a feed motion directly behind the cutting head 10, is pressed against the base lamellar retaining transport assembly 7, using a pressing shoe 5, thus ensuring the correct positioning of the moved floor panel 2 and creating the conditions for cutting the grooves 21 of a repetitive shape along a predetermined length of this floor panel 2.

Then, the floor panel 2 is moved from the pressing shoe 5 to the working area of the machining unit 4, with the mounted cutting head 11 over the lamellar retaining transport assembly 7. After the edge 14 of the short side of the floor panel 2 has crossed the axis X2 of the spindle 24, the machining unit 4 moves towards the underside 12 of the floor panel 2 and the teeth 40 of the cutters 39. 1, 39.2, 39. 3, 39. 4, 39. 5, 39. 6, 39.7 move in the core 13 parallel to the cut grooves 21, giving them the final shape of an isosceles trapezoid cross-section of the groove 22. Simultaneous cutting of the grooves 21 and 22 is performed until the length of the cut grooves 21 in the core 13 of the floor panel 2 is reached. Then, the machining unit 3 with the cutting head 10 is automatically withdrawn from the core 13 of the floor panel 2, establishing at the point where the machining is terminated the boundary line 49 that indicates the end of machining with its subsequent return to the starting position, 1 mm above the underside 12 of the floor panel 2. In the starting position, the working plane of the cutters 33.1, 33.2, 33.3, 33.4, 33.5, 33. 6, 33.7 of the cutting head 10 is at a height of 1 mm above the underside 12 of the floor panel 2, and the floor panel 2 performs the feed motion and the cutting of the parallel grooves 22 by the cutting head 11 in the core 13 of the floor panel 2 continues until the boundary line 49 indicating the end of machining is reached. Then, the machining unit 4 with the cutting head 11 is automatically withdrawn from the core 13 of the floor panel 2, assuming the starting position in which the working plane of the cutters 39.1; 39.2; 39.3; 39.4; 39.5; 39.6; 39.7 is at a height of 1 mm above the underside of the floor panel 2.

As shown in FIG. 9a, the surface without grooves on the underside 12 of the floor panel 2, contained between the boundary line 49 indicating the machining end and the edge 19 of the short side of the length L1′, constitutes the second retaining and mounting surface 50. The working sequences for cutting the grooves 22 of the floor panel 2 are performed by the machining units 3, 4 in the device 1 continuously at a feed rate of up to 200 m/min. The assumption of the working position in the core 13 of the floor panel 2 and the rest position by the machining units 3 and 4 is performed by means of a servo mechanism.

The movement of the floor panel 2 during groove cutting is performed together with the lamellar retaining transport assembly 7 and the lamellar pressing transport assemblies 8, 9 of the device 1. The device 1 can be made in either a vertical or horizontal version. The choice of the structural solution depends on the surroundings of the manufacturing apparatus and local conditions.

Preferably, the vertical arrangement of the feeding and machining assembly is designed in particular to perform the cutting of the grooves 21, 22, 28 in the core 13 of the floor panel 2 made of a synthetic material, a rock composite with plasticisers and binding agents or other plastic agglomerates with electrostatic properties, which hinder the discharge of the chips formed during the cutting of the grooves and cause chips to be deposited on the outer surfaces of the panel.

The frictional lamellar elements 18 are made of a material with non-slip properties and form the outer contact side of the transport assemblies 7, 8, 9 of the device 1. These frictional lamellar elements 18 contact the machined floor panel 2 on the retaining side and the pressing side, adhering over a large area of the transported and machined floor panels 2. In addition, the frictional lamellar elements 18 on the side of the lamellar retaining transport assembly 7 and on the side of the lamellar pressing transport assembly 8, 9 have independent synchronous drives. The machined floor panels 2 are clamped between the frictional lamellar elements 18 of the lamellar retaining transport assembly 7 and the lamellar pressing transport assemblies 8, 9 and perform a linear movement in the device 1 according to the feed direction. The release of the clamping of the floor panels 2 takes place on the outlet side of the device 1. This transport solution for the machined floor panel 2 provides a favourable condition whereby the tractive force induced by friction is larger than the actual feed force, which is a prerequisite for the use of linear feed speeds>100 m/min that exclude slippage of the machined floor panel 2 in the clamping and feeding system of the device 1.

The method of imparting feed motion to the machined floor panels 2 by clamping and moving them between the frictional lamellar elements 18 of the lamellar retaining transport assembly 7 and the lamellar pressing transport assemblies 8, 9 has an important technical advantage over commonly used transport systems based on drive rollers with limited contact with the machined object being moved.

### Reference Signs List

1 groove cutting device
2 floor panel
3 machining unit
4 machining unit
5 pressing shoe
6, 6′ support rollers
7 lamellar retaining transport assembly
8 lamellar pressing transport assembly at the inlet
9 lamellar pressing transport assembly at the outlet
10 cutting head
11 cutting head
12 underside
13 core
14 edge of the short side of the panel
15 first lower retaining and mounting surface
16 boundary line indicating the machining start point
17 groove
18 frictional lamellar element
19 edge of the short side of the panel
21 groove
22 groove
23 first spindle
24 second spindle
25 mounting tongue
26 mounting groove
27 cutting head
28 groove
29 cutter
30 tooth
31 sleeve
32 spacer
33.1÷33.7 cutters
34 disc-shaped body of the cutter
35 tooth
36 peripheral cutting edge
37 lateral cutting edge
38 lateral cutting edge
39.1÷39.7 cutters
40 tooth
41 peripheral cutting edge
42 lateral cutting edge
43 lateral cutting edge
44 cutters
45 tooth
47 lateral cutting edge
48 lateral cutting edge
49 boundary line indicating the machining end
50 second retaining and mounting surface
51 right sidewall of the groove
52 left sidewall of the groove
52a left sidewall of the groove
53 bottom of the groove
54 sidewall of the groove
55 bottom of the groove
56 right sidewall of the groove
57 bottom of the groove
58 flooring
59 adhesive joint
60 adhesive fin
U direction of movement of floor panels
α inclination angle
Y1 axis of rotation
Y2 axis of rotation
X1 axis of rotation
X2 axis of rotation
X3 axis of rotation
D cutter diameter
D1÷D7 gradually changing cutter diameters
r1 oval radius
L1 length of the retaining and mounting surface
L1′ length of the retaining and mounting surface
h groove height
S1 groove outer width
S2 groove inner width
S3 spacing between the sidewalls of adjacent grooves
S4 groove outer width
S5 groove inner width
S6 spacing between the sidewalls of adjacent grooves
S7 groove outer width
S8 groove inner width
S9 spacing between the sidewalls of adjacent grooves

1. A method of machining parallel grooves (17, 21, 22, 28) in an underside (12) of a floor panel (2), using a device (1) with rotary machining units (3, 4) in a form of cutting heads (10, 11, 27), the method comprising:
inserting the floor panel (2) between a lamellar retaining transport assembly (7) and a lamellar pressing transport assembly (8, 9);
clamping the floor panel (2) between the lamellar retaining transport assembly (7) and the lamellar pressing transport assembly (8, 9) and subjecting the floor panel (2) to a feed motion through linear movement;
putting the cutting head (10, 11, 27) into a rotary motion around the axis of rotation (X1, X2, X3; Y1, Y2), and
machining the parallel grooves (17, 21, 22, 28) in the underside (12) of the floor panel (2), using the feed motion imparted to it by the lamellar retaining transport assembly (7) and by the lamellar pressing transport assembly (8, 9),
wherein
machining of the parallel grooves (17, 21, 22, 28) in the underside (12) of the floor panel (2) is performed with the cutting head (10, 11) comprising a set of axially separated profile disk cutters (33.1, 33.2, 33.3, 33.4, 33.5, 33.6, 33.7; 39.1, 39.2, 39.3, 39.4, 39.5, 39.6, 39.7) with stepped diameters (D1, D2, D3, D4, D5, D6, D7), and wherein the machining of the parallel grooves (17, 21, 22, 28) takes place at the inclination of the axis of rotation (X1, X2; Y1, Y2) of the spindle (23, 24) of the cutting head (10, 11) at an angle (+α, α) relative to the plane of the underside (12) of the machined floor panel (2).

2. The method according to claim 1, characterised in that the floor panel (2) is imparted a feed motion through the lamellar retaining transport assembly (7) and the lamellar pressing transport assembly (8, 9) with the use of frictional lamellar elements (18).

3. The method according to claim 1, characterised in that two separated pressing transport assemblies (8, 9) are used, with at least one cutting head (10, 11, 27) located between said pressing transport assemblies.

4. The method according to claim 3, characterised in that a stabilising element in the form of a pressing shoe (5) is located between the separated pressing transport assemblies (8, 9).

5. The method according to claim 1, characterised in that the disc cutters (33.1, 33.2, 33.3, 33.4, 33.5, 33.6, 33.7; 39.1, 39.2, 39.3, 39.4, 39.5, 39.6, 39.7) with inclined peripheral cutting edges (36, 41) are used, cutting the bottoms (53, 57) of the grooves (21, 22) parallel to the plane of the underside (12) of the floor panel (2), wherein the inclination angle (+α, −α) of the peripheral cutting edges (36, 41) relative to the axis of rotation (X1, X2; Y1, Y2) of the cutting head (10, 11) is equal to the inclination angle (+α, −α) of the axis of rotation (X1, X2; Y1, Y2) of the cutting head (10, 11) relative to the plane of the underside (12) of the machined floor panel (2).

6. The method according to claim 1, characterised in that the disc cutters (33.1, 33.2, 33.3, 33.4, 33.5, 33.6, 33.7; 39.1, 39.2, 39.3, 39.4, 39.5, 39.6, 39.7, 44) used are separated by spacers (32) on the cutting head (10, 11, 27) on the spindle (23, 24).

7. The method according to claim 1, characterised in that the milling of the parallel grooves (17, 21, 22, 28) is performed as counter-rotating milling.
